(19) United States
(12) Patent Application Publication
(10) Pub. No.: US 2026/0181488 A1
(43) Pub. Date: Jun. 25, 2026

(54) Candidate Cell Activation for Layer 1/Layer 2 Triggered Mobility

(71) Applicant: Apple Inc., CUPERTINO, CA (US)

(72) Inventors: Hong HE, San Jose, CA (US); Chunxuan YE, San Diego, CA (US); Dan WU, Beijing (CN); Dawei ZHANG, Saratoga, CA (US); Jie CUI, San Jose, CA (US); Oghenekome OTERI, San Diego, CA (US); Wei ZENG, Saratoga, CA (US)

(21) Appl. No.: 18/835,147

(22) PCT Filed: Aug. 1, 2023
(86) PCT No.: PCT/CN2023/110582

§ 371 Date: Aug. 1, 2024

(51) Int. Cl. H04W 36/00; H04W 36/08

(52) U.S. Cl. CPC H04W 36/0058; H04W 36/08

(57) ABSTRACT

A user equipment (UE) configured to decode, from signaling received from a base station, configuration information for a layer 1 (L1)/layer 2 (L2) triggered mobility (LTM) procedure, configure transceiver circuitry to transmit a channel state information (CSI) report for LTM to the base station of the serving cell, the CSI report comprising measurement data for one or more candidate cells, decode, from signaling received from the base station, a medium access control (MAC) control element (CE) cell switch command for the LTM procedure and switch from the serving cell to one of the candidate cells based on the decoded MAC CE cell switch command for the LTM procedure.

### TECHNICAL FIELD

This application relates generally to wireless communication systems, and in particular relates to candidate cell activation for Layer 1/Layer 2 triggered mobility.

### BACKGROUND

A user equipment (UE) may connect to a network with Layer 1 (L1)/layer 2 (L2) triggered mobility (LTM). LTM generally refers to a mobility procedure that uses a measurement report with measurement information for one or more candidate cells. It has been identified that there is a need for mechanisms that facilitate the implementation of LTM.

### SUMMARY

Some exemplary embodiments are related to an apparatus of a user equipment (UE), the apparatus having processing circuitry configured to decode, from signaling received from a base station, configuration information for a layer 1 (L1)/layer 2 (L2) triggered mobility (LTM) procedure, configure transceiver circuitry to transmit a channel state information (CSI) report for LTM to the base station of the serving cell, the CSI report comprising measurement data for one or more candidate cells, decode, from signaling received from the base station, a medium access control (MAC) control element (CE) cell switch command for the LTM procedure and switch from the serving cell to one of the candidate cells based on the decoded MAC CE cell switch command for the LTM procedure.

Other exemplary embodiments are related to a processor configured to decode, from signaling received from a base station, configuration information for a layer 1 (L1)/layer 2 (L2) triggered mobility (LTM) procedure, configure transceiver circuitry to transmit a channel state information (CSI) report for LTM to the base station of the serving cell, the CSI report comprising measurement data for one or more candidate cells, decode, from signaling received from the base station, a medium access control (MAC) control element (CE) cell switch command for the LTM procedure and switch from the serving cell to one of the candidate cells based on the decoded MAC CE cell switch command for the LTM procedure.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for layer 1 (L1)/layer 2 (L2) triggered mobility (LTM) according to various exemplary embodiments.

FIG. 5 shows an exemplary deployment scenario according to various exemplary embodiments.

FIG. 6 shows an exemplary abstract syntax notation. one (ASN.1) used to configure a transmission configuration indicator (TCI) state list for LTM candidate cells according to various exemplary embodiments.

FIG. 7 shows different examples of TCI state configurations for LTM according to various exemplary embodiments.

FIG. 8 shows examples of exemplary medium access control (MAC) control elements (CEs) according to various exemplary embodiments.

FIG. 9 shows an example of the exemplary reference signal (RS) resource indicator field according to various exemplary embodiments.

### DETAILED DESCRIPTION

The exemplary embodiments may be further understood with reference to the following description and the related appended drawings, wherein like elements are provided with the same reference numerals. The exemplary embodiments relate to layer 1 (L1)/layer 2 (L2) triggered mobility (LTM).

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

Those skilled in the art will understand that LTM may generally refer to a mobility procedure during which the UE collects measurement data associated with one or more candidate cells and sends a lower-layer measurement report to the network. The network may switch the UE to one of the candidate cells based on the measurement report. For example, the network may send a cell switch command medium access control (MAC) control element (CE) to the UE. However, reference to LTM is merely provided for illustrative purposes. Different entities may refer to a similar concept by a different name (e. g., lower layer triggered mobility, etc.).

The exemplary embodiments are further described with regard to a fifth generation (5G) New Radio (NR) network that supports LTM. However, reference to a 5G NR network is merely provided for illustrative purposes. The exemplary embodiments may be utilized with any appropriate type of network (e. g., 5G, 5G advanced, 6G, etc.) that supports LTM.

The exemplary embodiments introduce techniques related to beam management for candidate cells in LTM. In one aspect, the exemplary embodiments relate to candidate cell reference signal configuration and measurement reporting for LTM. In another aspect, the exemplary embodiments relate to candidate cell transmission configuration indicator (TCI) state configuration for LTM. In another aspect, the exemplary embodiments relate to candidate cell TCI state activation for LTM. The exemplary techniques introduced herein may be used independently from one another, in conjunction with currently implemented LIM mechanisms, in conjunction with future implementations of LTM or independently from other LTM mechanisms.

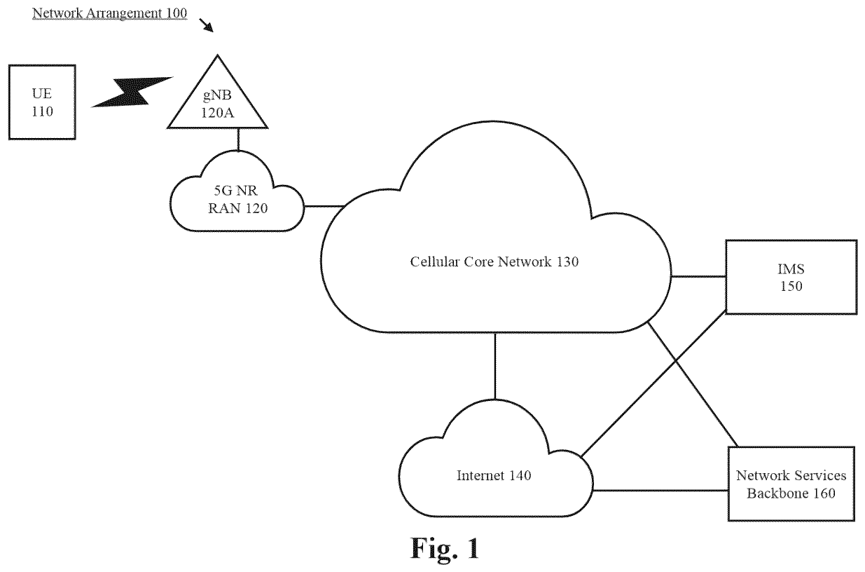

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., sixth generation (6G) RAN, 5G cloud RAN, a next generate RAN (NG-RAN), a legacy cellular network, a wireless local area network (WLAN), etc. ) and the UE 110 may also communicate with networks over a wired connection. Therefore, the UE 110 may have a 5G NR chipset to communicate with the NR RAN 120 and, optionally, any other appropriate type of chipset to communicate with other types of networks.

The 5G NR RAN 120 may be a portion of a cellular network that may be deployed by a network carrier (e.g., Verizon, AT&T, Sprint, T-Mobile, etc.). The 5G NR RAN 120 may include cells and base stations that are configured to send and receive traffic from UEs that are equipped with the appropriate cellular chip set. In this example, the 5G NR RAN 120 includes the gNB 120A. However, reference to a gNB is merely provided for illustrative purposes, the exemplary embodiments may be utilized with any appropriate type of access node (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., Servers, network storage arrangements, etc.) that implement a suite of services that may be used to extend the functionalities of the UE 110 in communication with the various networks.

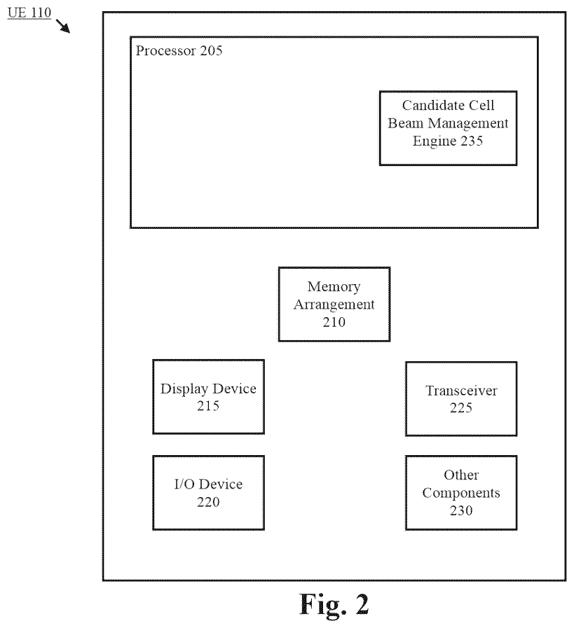

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may, for example, multiple panels each comprising one or more antenna elements, an audio input device, an audio output device, a power supply, a data acquisition device, ports to electrically connect the UE 110 to other electronic devices, etc.

The processor 205 may be configured to execute a plurality of engines of the UE 110. For example, the engines may include a candidate cell beam management engine 235. The candidate cell management engine 235 may perform various operations related to candidate cell beam management such as, but not limited to, receiving candidate cell reference signal configuration information for LTM, generating a CSI report for a candidate cell, receiving candidate cell TCI state configuration information for LTM and TCI state activation for LTM.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of Hankun consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

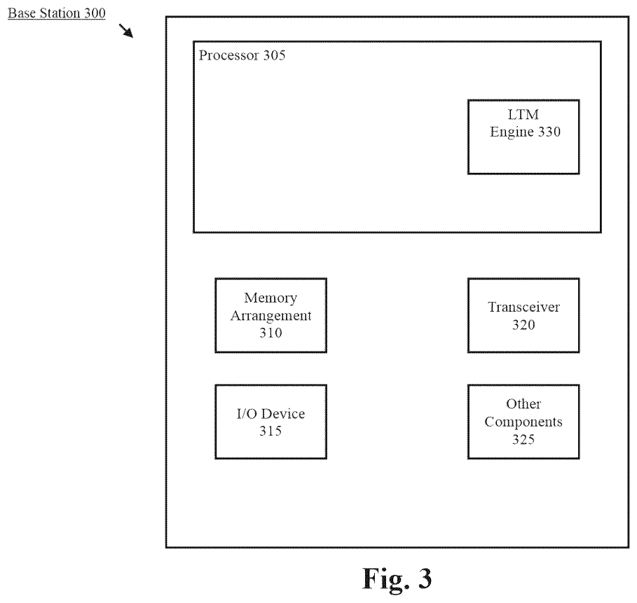

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include an LTM engine 330. The LTM engine 330 may perform various operations related to the configuration and performance of LTM.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

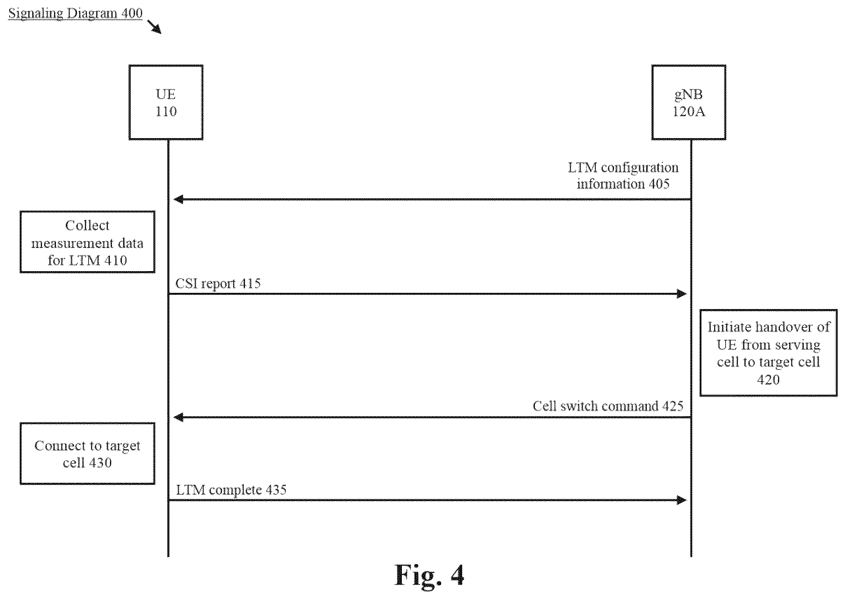

FIG. 4 shows a signaling diagram 400 LTM according to various exemplary embodiments. The signaling diagram 400 is described with regard to the UE 110 and the gNB 120A of FIG. 1.

The signaling diagram 400 is provided as a general overview of an example of LTM to provide context for the exemplary embodiments introduced herein. The exemplary embodiments are not limited to the LTM procedure described in the signaling diagram 400 and may be utilized in any appropriate type of mobility procedure.

In 405, the UE 110 receives LTM configuration information from the gNB 120A. The gNB 120A may operate one or more serving cells for the UE 110. The LTM configuration information may be provided to the UE 110 via radio resource control (RRC) signaling or in any other appropriate manner.

The LTM configuration information may include information that facilitates the collection and reporting of measurement data for candidate cells in LTM. To provide some examples, the LTM configuration information may include identification information for candidate cells, candidate cell resource signal configuration information, trigger conditions for sending a measurement report and/or any other appropriate type of information that may be used for the collection and reporting of measurement data for LTM.

In some embodiments, a group of CSI measurement resources may be configured for each candidate cell. Throughout this description, reference to the term “measurement resource” may refer to network resources on which the UE 110 is to perform CSI measurements. In the examples below, reference is made to the UE 110 may perform L1-RSRP measurements on synchronization signal/physical broadcast channel blocks (SSBs). However, the exemplary embodiments are not limited to SSB based L1-RSRP and may perform any appropriate type of measurement for LTM on any other appropriate type of signal.

The LTM configuration information may further include information that facilitates candidate cell activation in LTM. To provide some examples, the LTM configuration information may include candidate cell TCI state configuration information and quasi co-location (QCL) configuration information. The exemplary embodiments related to candidate cell TCI state configuration and candidate cell activation will be described in detail below after the signaling diagram 400.

In 410, the UE 110 collects measurement data for LTM. For example, the UE 110 may perform L1-RSRP measurements for one or more candidate cells based on CSI-reference signal (RS), SSB and/or any other type of resource. However, reference to L1-RSRP is merely provided for illustrative purposes, the exemplary embodiments may use any appropriate type of measurement data for LTM.

In 415, the UE 110 sends the CSI report to the gNB 120A. In 420, the gNB 120A initiates a handover of the UE 110 from a serving cell to a target cell based on the measurement data provided in the CSI report. The network may select a target cell for LTM from the candidate cells in the CSI report. Accordingly, in some examples, the terms “candidate cell” and “target cell” may be used interchangeably to refer to the same cell.

In 425, the UE 110 receives a cell switch command from the gNB 120A. For example, the UE 110 may receive a medium access control (MAC) control element (CE) comprising a cell switch command. However, reference to a MAC CE is merely provided for illustrative purposes. The gNB 120A may provide this type of indication to the UE 110 in any appropriate manner.

In 430, the UE 110 may perform a random access procedure towards the target cell or may attempt to use any other appropriate type of procedure to switch from a serving cell of the gNB 120A to the target cell in response to the cell switch command. In 435, the UE 110 sends a message to the gNB 120a indicating that the LTM procedure is successfully completed. In this example, it is assumed that the UE 110 successfully connects to the target candidate cell. However, in an actual deployment scenario, the LTM procedure may fail for any of a variety of different reasons.

As will be described in more detail below, the exemplary embodiments introduce various exemplary IEs for LTM configuration information that may be provided to the UE 110 in one or more RRC messages. The exemplary IEs may facilitate the implementation of LTM in a 3GPP network by addressing specific issues identified during the development of LTM in a manner that limits signaling overhead, latency and/or complexity. Throughout this description, any reference to an exemplary IE by a specific name is provided as an example and to differentiate between the exemplary IEs described herein. Different entities may refer to similar types of IEs or parameters by different names.

The LTM configuration information may include information that facilitates the collection and reporting of measurement data for candidate cells in LTM. It has been identified that it would be beneficial to provide LTM measurement resource configuration information for SSB based measurements of candidate cells outside of serving cell configuration information (e.g., ServingCellConfig IE(s), etc.) and LTM candidate cell configuration information. The exemplary embodiments introduce an arrangement of IEs that may be used to configure the measurement resources for LTM candidate cells and associate the measurement resources with the CSI reports configured on the serving cell.

According to some aspects, a new IE may be introduced to provide LIM candidate cell configuration information to the UE 110. Throughout this description, this IE may be referred to as “LTM-Info-r18.” In some examples, LTM-info-r18 may be included in a CellGroupConfig IE that is used to configure information for a cell group consisting of one or more candidate cells. However, reference to LTM-Info-r18 being included in the CellGroupConfig IE is provided as one example and the exemplary IE may be included in any appropriate type of message.

LTM-Info-r18 may convey various parameters to the UE 110 for an LTM candidate cell. To provide some examples, LTM-Hankun Info-r18 may include an ltm-CandidateCell-ID IE configured to indicate an identifier or index for a candidate cell from a cell group of one or more LIM candidate cells configured for UE 110. In some embodiments, the UE 110 may receive LTM-Info-r18 for each candidate cell of a cell group. LTM-Info-r18 may also include an ltm-CandidateCell-PCI IE configured to include the PCI of the candidate cell. LTM-Info-r18 may also include a ssbFrequency IE configured to indicate the frequency of the SSB associated with this candidate cell and may be expressed using absolute radio frequency channel number (ARFCN). LTM-Info-r18 may also include a subcarrierspacing IE configured to indicate the subcarrier spacing of the SSB (e.g., 15 kilohertz (kHz), 30 kHz, 120 kHz, 240 kHz, etc.).

### Ltm-info-r18 May Further Include an Ltm-ssb-mtc-r18 Ie

configured to indicate measurement timing configurations for a set of SSBs, e.g., timing occasion at which the UE 110 may measure SSBs. The LTM-SSB-MTC-r18 may also include parameters such as periodicity and ssb-PositionsInBurst which may comprise one of a short bitmap (e.g., up to 4 bits), a medium bitmap (e.g., up to 8 bits) or long bitmap (e.g., up to 64 bits) for SSB. The examples provided above for short, medium and long bitmaps are not intended to limit the exemplary embodiments in any way, the exemplary embodiments may use bitmaps of any size.

LTM-Info-r18 may also include an ltm-Candidate-TCI-StateList IE configured to indicate a group of one or more TCI states for an LTM candidate cell configuration. In some embodiments, for each candidate cell, one or more of the IEs ltm-CandidateCell-PCI, ssbFrequency and subcarrierspacing may be shared for one or more of the IEs ltm-SSB-MTC-r18 and ltm-Hankun candidate-Tci-Stateslist to avoid duplicate indication and minimize signaling overhead.

According to some aspects, a new IE may be introduced to provide LTM measurement resource configuration information to the UE 110. Throughout this description, this IE may be referred to as “LTM-CSI-ResourceConfig.”

LTM-CSI-ResourceConfig may be used to configure an SSB resource set comprising one or more intra-frequency or inter-frequency candidate cells. LTM-CSI-ResourceConfig may include an ltm-CSI-ResourceConfigID IE configured to provide an identifier for this resource set. In addition, LTM-CSI-ResourceConfig may include an ltm-CSI-SSB-ResourceList IE pointing to an SSB index for the candidate cell. LTM-CSI-ResourceConfig may further include an ltm-CSI-CandidateCell-ID-List IE configured to indicate the candidate cell IDs of the SSBs in ltm-CSI-SSB-ResourceList. In some examples, 1tm-CSI-CandidateCell-ID-List has the same number of entries as ltm-CSI-SSB-ResourceList and the first entry of the list indicates the value of the candidate cell ID for the first entry of ltm-CSI-SSB-ResourceList, the second entry of the list indicates the value of the candidate cell ID for the second entry of ltm-CSI-SSB-ResourceList and so on.

According to some aspects, a new IE may be introduced to provide LTM measurement channel configuration information to the UE 110. Throughout this description, this IE may be referred to as “ltm-ResourcesForChannelMeasurement.”

Configuration information for a CSI report in LTM may be provided in an LTM-CSI-ReportConfig IE. Each LTM-CSI-ReportConfig IE may include an 1tm-ResourcesForChannelMeasurement IE configured to identify the measurement resources for inter-cell channel measurements associated with one or more candidate cells for LTM. For example, the ltm-ResourcesForChannelMeasurement IE may point towards ltm-CSI-ResourceConfigID so the UE 110 knows which resource set is to be used for a particular CSI report for LTM.

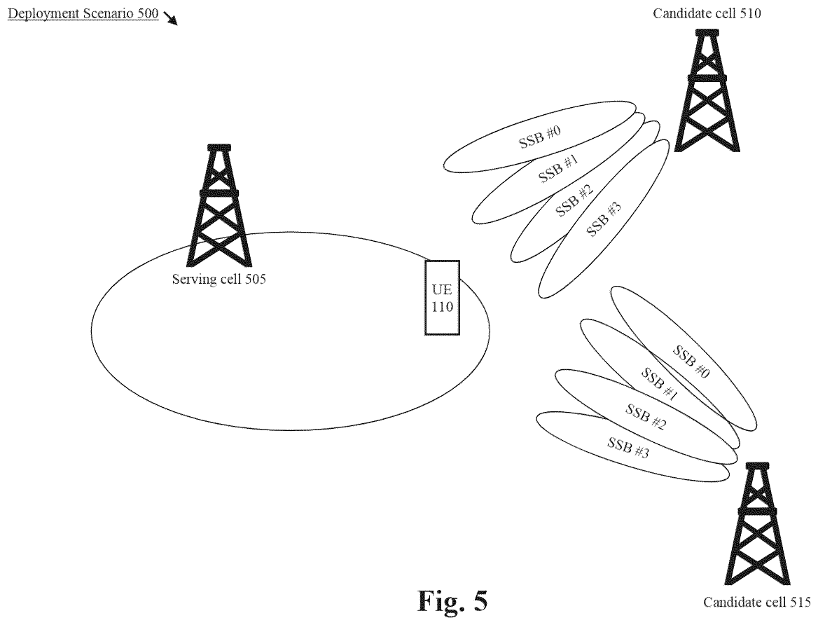

FIG. 5 shows an exemplary deployment scenario 500 according to various exemplary embodiments. The exemplary deployment scenario 500 is provided as an example to illustrate how the exemplary candidate cell configuration information described above may be applies to an exemplary deployment scenario.

The deployment scenario 500 shows the UE 110, a serving cell 505, a first candidate cell 510 and a second candidate cell 515. In this example, it may be assumed that the candidate cells 510-515 are inter-frequency candidate cells. It may also be assumed that the cells 505-515 are controlled by the gNB 120A. However, the example of three cells controlled by a single gNB is merely provided for illustrative purposes. The exemplary embodiments may apply to any number of cells operated by any number of base stations.

The UE 110 may receive the exemplary LTM-InfoList-r18 IE for the candidate cell 510 and the candidate cell 515. It may be assumed that for each candidate cell, the IE ltm-SSB-MTC-r18 indicates that a short bitmap is to be applied and the bit string is set to a value of ‘1111’ indicating that SSB index #0-3 are to be transmitted by the corresponding candidate cell.

Accordingly, in the deployment scenario 500, candidate cell 510 is shown with SSBs indexed #0-3 and candidate cell 515 is also shown with SSBs indexed #0-3.

The UE 110 may also receive one or more LTM-CSI-ResourceConfig IEs each identifying resource sets comprising measurement resources for candidate cell 510, candidate cell 515 or both candidate cells 510-515. In addition, the UE 110 may receive one or more LTM-CSI-ReportConfig IEs with the exemplary ltm-resourcesForChannelMeasurement IE introduced herein pointing towards the resource set to be used by the UE 110 for a particular LTM CSI report.

In some embodiments, the network may provide LTM configuration information to the UE 110 based on a layer 3(L3 ) measurement report previously provided by the UE 110. Thus, the network may configure resource sets for LTM CSI reports based on latest L3 measurement report from the UE 110. In the deployment scenario 500, the network may configure the UE 110 with three different LTM CSI report type indications indexed #1-3 using LTM-CSI-ReportConfig IEs and the exemplary ltm-resourcesForChannelMeasurement IE in conjunction with LTM-CSI-ResourceConfig IEs. For example, CSI report #1 may be configured to include measured L1-RSRP for candidate cell 510 SSBs indexed #2, #3 and candidate cell 515 SSBs indexed #0, #1. CSI report #2 may be configured to include measured L1-RSRP for candidate cell 510 SSBs indexed #0-3 and no measurement data for candidate cell 515. CSI report #3 may be configured to include measured L1-RSRP for candidate cell 515 SSBs indexed #0-3 and no measurement data for candidate cell 510. The examples provided above are not intended to limit the exemplary embodiments in any way. Instead, the examples are provided to demonstrate one example of how the exemplary IEs may be used to configure the UE 110 with measurement resources for LTM and associated the measurement resources with specific CSI reports.

The LTM configuration information may further include information that facilitates TCI state activation for candidate cells in LTM. Those skilled in the art will understand that a TCI state may indicate that a beam is quasi co-located (QCL) to a specific network resource (e.g., SSB, etc.) and define a search space. Thus, a TCI state may indicate the location of one or more SSs relative to a network resource. With regard to LTM, a TCI state may be activated to facilitate the cell switch from a serving cell to a target candidate cell.

The exemplary embodiments may be used to configure TCI states for candidate cells in LTM. According to some aspects, the exemplary embodiments may be used to configure the qcl-type source measurement resource. The exemplary embodiments are described with regard to an LTM-Candidate-TCI-State IE identifying one or more TCI states for an LTM candidate cell comprising an LTM-QCL-Info IE. The QCL-type source measurement resource may be provided as part of the LTM-QCL-Info IE.

In one approach, QCL-source measurement resource in an LTM-QCL-Info IE of a TCI state may be limited to the SSB resources indicated by the ssb-PositionsInBurst IE for a corresponding candidate cell. In one example, a ltm-Candidate-Tci-Stateslist IE may be used to provide a candidate cell specific TCI state list configuration comprising TCI states of a single candidate cell. This exemplary IE may be included in the LTM-Info-r18 IE introduced above or provided to the UE 110 in any other appropriate manner.

In another example, a common TCI state list for one or more candidate cells may be used. A new IE 1tm-CandidateCell-Id may be added to TCI-state configuration or QCL-info configuration to indicate which candidate cell the corresponding LTM-Candidate-TCI state is associated.

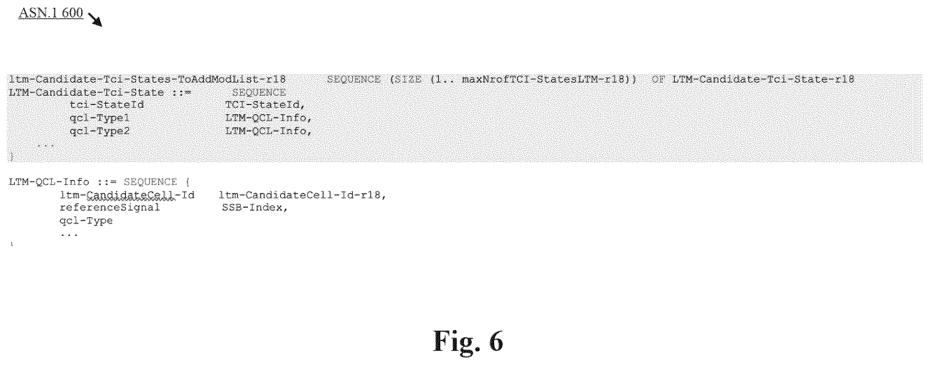

FIG. 6 shows an exemplary abstract syntax notation. one (ASN.1) 600 to configure a TCI state list for LTM candidate cells according to various exemplary embodiments. The ASN.1 600 may be used to implement a common TCI state list for one or more candidate cells. In this example, the ltm-CandidateCell-Id IE may be used to indicate which one or more candidate cells are associated with the QCL information provided in the LTM-Candidate-Tci-State of the candidate state list.

In another approach, a combination of SSB and tracking reference signal (TRS) resource sets may be used to convey the QCL source measurement resource. The exemplary embodiments introduce a ltm-TRS-resourcesetlist IE which may be included in the LTM-Info-r18 IE for each candidate cell. The ltm-TRS-resourcesetlist IE may indicate a group of one or more TRS resource sets associated with a candidate cell. In some embodiments, point A of the candidate cell may be explicitly configured using absolute radio-frequency channel number (ARFCN). If not configured, the UE 110 may assume a same point A as the current serving cell.

For a candidate cell i, QCL source reference signal in an LTM-QCL-Info of the TCI state may be associated with a SSB or TRS resource in the ltm-TRS-resourcesetlist of the candidate cell. In some embodiments, multiple candidate cell specific TCI state lists may be used. In other embodiments, a common TCI state list may be used to configure TCI states for more than one candidate cells in LTM.

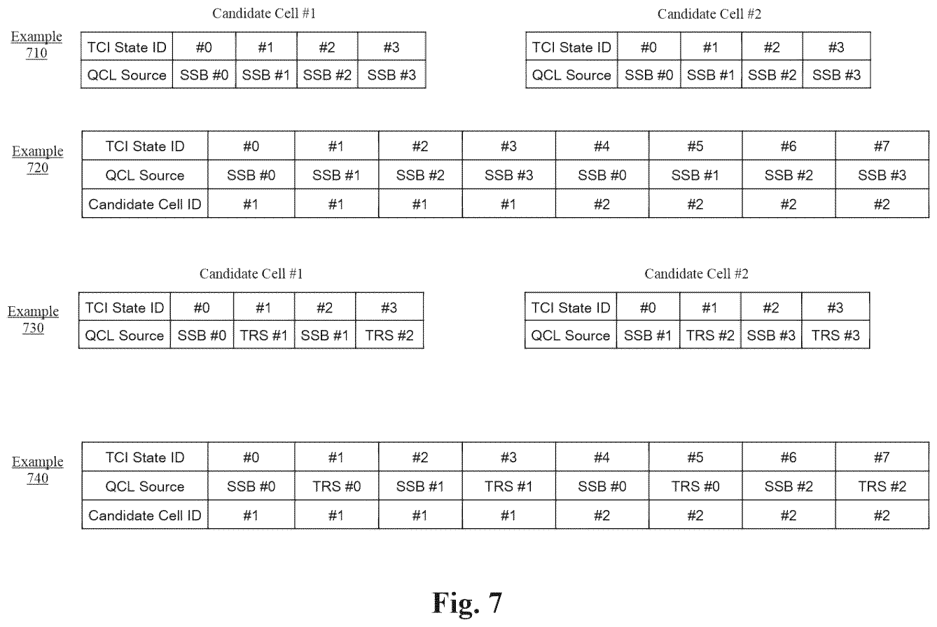

FIG. 7 shows different examples of TCI state configurations for LTM according to various exemplary embodiments. The examples 710-740 are described with regard to two candidate cells for LTM, candidate cell #1 and candidate cell #2.

In example 710, the TCI state list is configured on a per-candidate cell basis. Accordingly, each candidate cell corresponds to a different LTM TCI-state list. In addition, the QCL source reference signal for each TCI state is limited to the SSB resources configured for L1 measurements. In example 710, it may be assumed that for each candidate cell SSBs indexed #0-#3 are indicated in the ssb-PositionsInBurst IE and available to be assigned to a TCI state for the corresponding candidate cell.

In example 710, four TCI state IDs are provided for candidate cell #1 and indexed #0-3. The QCL source reference signal indicated by LTM-QCL-Info IE for TCI state #0 is SSB #0, TCI state #1 is SSB #1, TCI state #2 is SSB #2 and TCI state #3 is SSB #3. In addition, four TCI state IDs are provided for candidate cell #2 and indexed #0-3. The QCL source reference signal indicated by LTM-QCL-Info IE for TCI state #0 is SSB #1, TCI state #1 is SSB #0, TCI state #2 is SSB #3 and TCI state #3 is SSB #2.

In example 720, the TCI state list is common to multiple candidate cells. Accordingly, candidate cell #1 and candidate cell #2 share a same TCI state list for LTM. In addition, the QCL source measurement resource for each TCI state is limited to the SSB resources configured for L1 measurements. In example 720, it may be assumed that for each candidate cell SSBs indexed #0-#3 are indicated in the ssb-PositionsInBurst IE and available to be assigned to a TCI state for the corresponding candidate cell.

In example 720, eight TCI state IDs are provided for common TCI state list and indexed #0-7. The QCL source reference signal indicated by LTM-QCL-Info IE for TCI state #0 is SSB #0 of candidate cell #1, TCI state #1 is SSB #1 of candidate cell #1, TCI state #2 is SSB #2 of candidate cell #1 and TCI state #3 is SSB #3 of candidate cell #1, TCI state #4 is SSB #0 of candidate cell #2, TCI state #5 is SSB #1 of candidate cell #2, TCI state #6 is SSB #2 of candidate cell #2 and TCI state #7 is SSB #3 of candidate cell #2.

In example 730, the TCI state list is configured on a per-candidate cell basis. Accordingly, each candidate cell corresponds to a different LTM TCI-state list. In addition, the QCL source measurement resource for each TCI state may be the SSB resources configured for L1 measurements and/or TRS indicated in a TRS list. In example 730, it may be assumed that for each candidate cell SSBs indexed #0-#3 are indicated in the ssb-PositionsInBurst IE and available to be assigned to a TCI state for the corresponding candidate cell. There may also be a TRS list for candidate cell #1 indexed #0-4 and a TRS list for candidate cell #2 indexed #0-3.

In example 730, four TCI state IDs are provided for candidate cell #1 and indexed #0-3. The QCL source reference signal indicated by LTM-QCL-Info IE for TCI state #0 is SSB #0, TCI state #1 is TRS #1, TCI state #2 is SSB #1 and TCI state #3 is TRS #2. In addition, four TCI state IDs are provided for candidate cell #2 and indexed #0-3. The QCL source reference signal indicated by LTM-QCL-Info IE for TCI state #0 is SSB #1, TCI state #1 is TRS #2, TCI state #2 is SSB #3 and TCI state #3 is TRS #3.

In example 740, the TCI state list is common to multiple candidate cells. Accordingly, candidate cell #1 and candidate cell #2 share a same TCI state list for LTM. In addition, the QCL source measurement resource for each TCI state may be the SSB resources configured for L1 measurements and/or TRS indicated in a TRS list. In example 740, it may be assumed that for each candidate cell SSBs indexed #0-#3 are indicated in the ssb-PositionsInBurst IE and available to be assigned to a TCI state for the corresponding candidate cell. There may also be a TRS list for candidate cell #1 indexed #0-4 and a TRS list for candidate cell #2 indexed #0-3.

In example 740, eight TCI state IDs are provided for common TCI state list and indexed #0-7. The QCL source reference signal indicated by LTM-QCL-Info IE for TCI state #0 is SSB #0 of candidate cell #1, TCI state #1 is TRS #0 of candidate cell #1, TCI state #2 is SSB #1 of candidate cell #1 and TCI state #3 is TRS #1 of candidate cell #1, TCI state #4 is SSB #0 of candidate cell #2, TCI state #5 is TRS #0 of candidate cell #2, TCI state #6 is SSB #2 of candidate cell #2 and TCI state #7 is TRS #2 of candidate cell #2.

According to some aspects, the exemplary embodiments introduce techniques for TCI state activation of one or multiple candidate cells in LTM. The exemplary techniques may enable TCI state activation prior to the reception of the cell switch command. This may allow TCI state activation latency to be minimized and thus, reduce the overall LIM interruption time.

In some embodiments, a new MAC CE may be introduced to activate up to N TCI states from the TCI state list corresponding to a candidate cell. The exemplary MAC CE introduced herein may have a dedicated MAC subheader with a dedicated extended logical channel ID (eLCID) to differentiate with the TCI state activation/deactivation MAC CE for the current serving cell. In one example, a candidate cell may be indicated by a candidate cell ID field included in the exemplary MAC CE and all of the TCI states in the MAC CE may be associated with a single candidate cell.

In another example, the exemplary MAC CE may be configured for multiple candidate cells. The exemplary MAC CE may include multiple Cᵢ fields where each Cᵢ field indicates whether the TCI state associated with candidate cell ID i are activated. A first value (e.g., 1) may indicate there is at least one joint TCI state or a pair of TCI states (e.g., DL TCI state, UL TCI state) and a second value (e.g., 0) may candidate that no TCI state is activated for the corresponding candidate cell i. The exemplary MAC CE may further include multiple Pᵢ fields where a first value (e.g., 0) indicates there is a joint TCI state or a pair of TCI states (e.g., DL TCI state, UL TCI state) and a second value (e.g., 1) indicates that there are two joint TCI states or two pairs of TCI states (e. g., DL TCI state, UL TCI state). The exemplary MAC CE may also include a TCI state ID field configured to indicate the TCI state ID that is activated for the candidate cell.

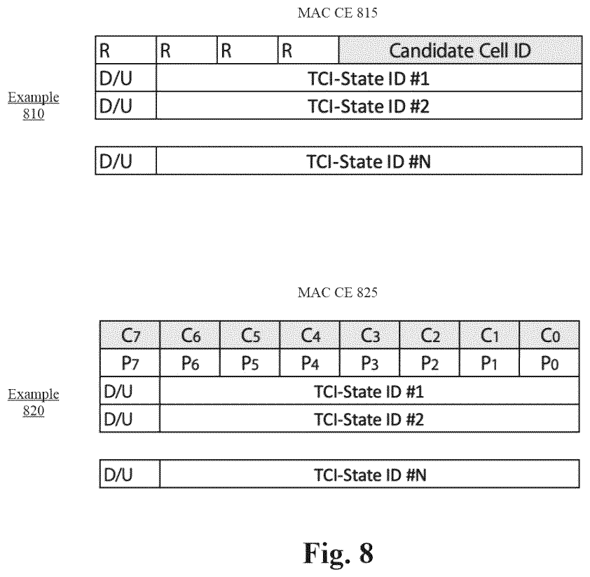

FIG. 8 shows examples of exemplary MAC CE described above. Example 810 shows a MAC CE 815 configured for TCI state activation of a single candidate cell. Example 820 shows a MAC CE 825 for TCI state activation for more than one candidate cell.

In some embodiments, a new field may be introduced to indicate the SSB indices from the SSBs that are reported by the UE 110 in a previous CSI measurement occasion. This new field may be referred to as a reference signal (RS) resource indicator. The exemplary RS resource indicator field may be included in a MAC CE, scheduling DCI from the serving cell or in any other appropriate signal.

The exemplary RS resource indicator field may include N bits represented as b₀,b₁,b₂ . . . b_{N-1} where N equals the total number of reported measurement resources for all candidate cells in a single CSI report. Thus, each of the N bits (bᵢ) corresponds to a different SSB. The measurement resources corresponding to the largest measured RSRP may be configured as b₀, the measurement resources with the second largest RSRP may be configured as b₁ and so on. When a bit (bᵢ) is set to a first value (e.g., 1), this may indicate the TCI state configured to use the corresponding measurement resource as a QCL source measurement resource is activated. When a bit (bᵢ) is set to a second value (e.g., 0), this may indicate the TCI state configured to use the corresponding measurement resource as a QCL source measurement resource is not activated.

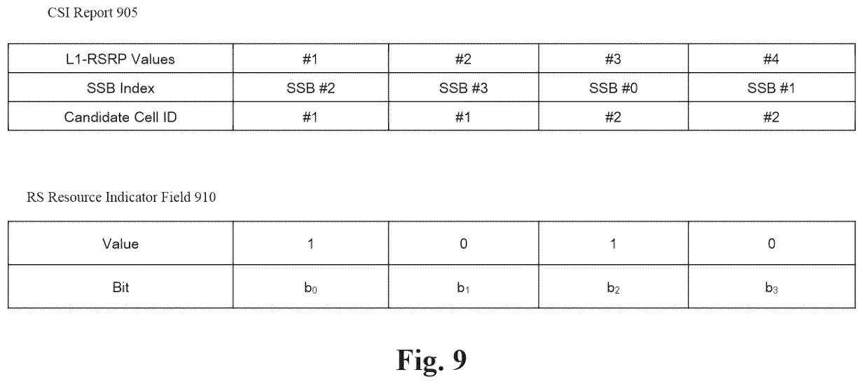

FIG. 9 shows an example of the exemplary RS resource indicator field described above. In this example, it may be assumed that N=4 based on RRC configuration.

Initially, the UE 110 provides a CSI measurement report 905 to the network for LTM. CSI report 905 comprising measured L1-RSRP values for SSB #2 of candidate cell #1, SSB #3 of candidate cell #1, SSB #0 of candidate cell #2 and SSB #1 of candidate cell #2. It may be assumed that RSRP value #1 for SSB #2 of candidate cell #1 is the highest RSRP value, RSRP value #2 for SSB #3 of candidate cell #1 is the second highest RSRP value, RSRP value #3 for SSB #0 of candidate cell #2 is the third highest RSRP value and RSRP value #4 for SSB #1 of candidate cell #2 is the lowest RSRP value. As indicated above, the contents of the CSI report 905 may be used to encode the RS resource indicator field 910.

In this example, the RS resource indicator field 910 comprises b₀,b₁,b₂,b₃ because in this example N=4. b₀ corresponds to SSB #2 of candidate cell #1 because RSRP value #1 is the highest RSRP value, b₁ corresponds to SSB #3 of candidate cell #1 because RSRP value #2 is the second highest RSRP value, b₂ corresponds to SSB #0 of candidate cell #2 because RSRP value #3 is the third RSRP value and b₃ corresponds to SSB #1 of candidate cell #2 because RSRP value #4 is the highest RSRP value.

In this example, the network sends a signal (e.g., MAC CE, DCI, etc.) with the RS resource indicator field 910 set to the following values: b₀=1, b₁=0, b₂=1, b₃=0. Since b₀ and b₂ are set to 1, both the TCI state configured to use SSB #2 of candidate cell #1 as QCL source measurement resource and the TCI state configured to use SSB #0 of candidate cell #2 as QCL source measurement resource are activated. Since b₁ and b₃ are set to 0, neither the TCI state configured to use SSB #3 of candidate cell #1 as QCL source measurement resource nor the TCI state configured to use SSB #1 of candidate cell #2 as QCL source measurement resource are activated.

In some embodiments, upon receiving a physical downlink control channel (PDCCH) order that triggers contention-free random access (CFRA) operation, the TCI state that is associated with the SSB indicated by the PDDCH order DCI format may be activated. The candidate cell associated with the SSB and the TCI state may be explicitly indicated in the PDCCH order DCI using a candidate cell ID field.

To provide an example, assume that TCI state #2 is associated with SSB #3 of candidate cell #1. An exemplary DCI may activate a TCI state #2 by setting a candidate cell ID field to indicate candidate cell ID #1 and setting an SSB index field to indicate SSB #3. The exemplary DCI jointly activate TCI state and trigger CFRA operation by including a random access preamble index for CFRA operation. The CFRA procedure may be used to obtain the timing advance for the cell switch procedure.

In some embodiments, a group common DCI may be introduced to activate TCI states for multiple UEs. The exemplary DCI may contain N blocks, e.g., block #1, block #2 . . . block #N. Each block may be configured to include a candidate cell ID and an SSB index. As indicated above, a candidate cell ID and SSB index may be associated with a particular TCI state.

Each UE may be provided with an indication of a starting bit position to monitor for blocks comprising the TCI state activation indication for a candidate cell. In some embodiments, the number of bits for each block field may be different depending on a total number of candidate cells for each UE. In one example, a number of information bits in the DCI format 2_2 may be equal to or less that the payload size of DCI format 0_1 monitored in common search space (CSS) in the same serving cell.

### Examples

In a first example, a method performed by a user equipment (UE), comprising decoding, from signaling received from a base station, configuration information for a layer 1 (L1)/layer 2 (L2) triggered mobility (LTM) procedure, configuring transceiver circuitry to transmit a channel state information (CSI) report for LTM to the base station of the serving cell, the CSI report comprising measurement data for one or more candidate cells, decoding, from signaling received from the base station, a medium access control (MAC) control element (CE) cell switch command for the LTM procedure and switching from the serving cell to one of the candidate cells based on the decoded MAC CE cell switch command for the LTM procedure.

In a second example, the method of the first example, wherein the configuration information for the LTM procedure comprises a first information element (IE) for each candidate cell of a cell group, the first IE comprising one or more of a second IE configured to indicate a candidate cell ID, a third IE configured to indicate a physical cell ID (PCI), a fourth IE configured to indicate a frequency of a set of synchronization signal blocks (SSBs), a fifth IE configured to indicate measurement timing configurations of the set of SSBs and a sixth IE configured to indicate a group of one or more transmission configuration indicator (TCI) states.

In a third example, the method of the second example, wherein the first IE is included in a CellGroupConfig IE that is used to configure information for the cell group consisting of the one or more candidate cells.

In a fourth example, the method of the first example, wherein the configuration information for the LTM procedure comprises a LTM CSI resource configuration information element (IE) to configure a synchronization signal block (SSB) resource set for one or more intra-frequency or inter-frequency candidate cells.

In a fifth example, the method of the fourth example, wherein the LTM CSI resource configuration IE comprises an SSB resource list and a candidate cell Id List.

In a sixth example, the method of the fifth example, wherein a number of entries of the SSB resource list is equal to a number of entries of the candidate cell ID list.

In a seventh example, the method of the fifth example, wherein a first entry of the candidate cell ID list indicates a value of a candidate cell ID for a first entry of the SSB resource list.

In an eighth example, the method of the fourth example, wherein the configuration information for the LTM procedure further comprises an IE to configure resources for channel measurement for each LTM CSI resource configuration IE to associate with a CSI report, the resources for channel measurement IE configured to identify inter-cell channel measurement resources associated with the one or more candidate cells.

In a ninth example, the method of the first example, further comprising configuring the transceiver circuitry to transmit, prior to the CSI report for LTM, a layer 3 (L3) measurement report to the base station, decoding, from signaling received from the base station, multiple CSI report type indication for LTM, wherein each type of CSI report type indication corresponds to a different set of synchronization signal blocks (SSBs) and is configured by the network based on the L3 measurement report and generating the CSI report for LTM, wherein generating the CSI report for LTM comprises selecting one of multiple CSI report types for LTM based on the CSI report type indications received from the base station.

In a tenth example, the method of the first example, wherein the configuration information for the LTM procedure comprises a candidate cell transmission configuration indicator (TCI) state list comprising multiple TCI states.

In an eleventh example, the method of the tenth example, wherein the configuration information for the LTM procedure includes a first information element (IE) for each TCI state and a quasi co-location (QCL) source reference signal parameter of the first IE is limited to synchronization signal block (SSB).

In a twelfth example, the method of the eleventh example, wherein the candidate cell TCI state list is configured on a per candidate cell basis.

In a thirteenth example, the method of the eleventh example, wherein the candidate cell TCI state list is common to multiple candidate cells and includes multiple TCI states.

In a fourteenth example, the method of the tenth example, wherein the configuration information for the LTM procedure includes a first information element (IE) for each TCI state and a quasi co-location (QCL) source reference signal parameter of the first IE is limited to an index of a synchronization signal block (SSB) and an index of a tracking reference signal (TRS).

In a fifteenth example, the method of the fourteenth example, wherein the candidate cell TCI state list is configured on a per candidate cell basis.

In a sixteenth example, the method of the fourteenth example, wherein the candidate cell TCI state list is common to multiple candidate cells and includes multiple TCI states.

In a seventeenth example, the method of the first example, further comprising decoding, from signaling received from the base station prior to the MAC CE for the cell switch command for the LTM procedure, a second medium access control (MAC) control element (CE) configured to activate one or more TCI states for one or more candidate cells in LTM.

In an eighteenth example, the method of the seventeenth example, wherein the one or more TCI states in the second MAC CE are for a single candidate cell.

In a nineteenth example, the method of the seventeenth example, the one or more TCI states in the second MAC CE are for multiple candidate cells.

In a twentieth example, the method of the nineteenth example, wherein the second MAC CE comprises multiple candidate cell ID fields configured to indicate whether a TCI state associated with each respective candidate cell ID is activated.

In a twenty first example, the method of the twentieth example, wherein the second MAC CE further multiple second fields, each second field corresponding to one of the candidate cell ID fields and wherein each second field is set to a first value configured to indicate whether a joint TCI state or a pair of TCI states are to be used or a second value configured to indicate whether two joint TCI states or two pairs of TCI states are to be used.

In a twenty second example, the method of the first example, further comprising decoding, from signaling received from the base station prior to the MAC CE for the cell switch command, a signal comprising a reference signal (RS) resource indicator field.

In a twenty third example, the method of the twenty second example, wherein the RS indicator field consists of a set of bits comprising a number of bits equal to a number of measurement resources for all candidate cells in a previously reported CSI report, each bit of the set of corresponding to a different measurement resource.

In a twenty fourth example, the method of the twenty third example, wherein the set of bits are ordered based on the values of the measured reference signal receive powers (RSRPs) that are included in the previously reported CSI report.

In a twenty fifth example, the method of the twenty third example, wherein each bit is configured to indicate whether a transmission configuration indicator (TCI) state that uses a measurement resource corresponding to the respective bit as a quasi co-location source reference signal is activated.

In a twenty sixth example, the method of the first example, further comprising decoding, from signaling received from the base station prior to the MAC CE for the cell switch command for the LTM procedure, downlink control information (DCI) configured to jointly activate a transmission configuration indicator (TCI) state and trigger contention free random access (CFRA).

In a twenty seventh example, the method of the twenty sixth example, wherein the TCI state is indicated by a candidate cell ID and a synchronization signal block (SSB) index provided in the DCI.

In a twenty eighth example, the method of the first example, further comprising decoding, from signaling received from the base station prior to the MAC CE for the cell switch command for the LTM procedure, a group common downlink control information (DCI) configured to activate transmission configuration indicator (TCI) states for multiple UEs.

In a twenty ninth example, the method of the twenty eighth example, wherein the group common DCI comprises multiple blocks, each block comprising a candidate cell IE and synchronization signal block (SSB) index.

In a thirtieth example, a processor configured to perform any of the methods of the first through twenty ninth examples.

In a thirty first example, a user equipment (UE) comprising a transceiver configured to communicate with a network and a processor communicatively coupled to the transceiver and configured to perform any of the methods of the first through twenty ninth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, from signaling received from a base station, configuration information for a layer 1 (L1)/layer 2 (L2) triggered mobility (LTM) procedure;
configure transceiver circuitry to transmit a channel state information (CSI) report for LTM to the base station of the serving cell, the CSI report comprising measurement data for one or more candidate cells;
decode, from signaling received from the base station, a medium access control (MAC) control element (CE) cell switch command for the LTM procedure; and
switch from the serving cell to one of the candidate cells based on the decoded MAC CE cell switch command for the LTM procedure.

2. The apparatus of claim 1, wherein the configuration information for the LTM procedure comprises a first information element (IE) for each candidate cell of a cell group, the first IE comprising one or more of a second IE configured to indicate a candidate cell ID, a third IE configured to indicate a physical cell ID (PCI), a fourth IE configured to indicate a frequency of a set of synchronization signal blocks (SSBs), a fifth IE configured to indicate measurement timing configurations of the set of SSBs and a sixth IE configured to indicate a group of one or more transmission configuration indicator (TCI) states.

3. The apparatus of claim 2, wherein the first IE is included in a CellGroupConfig IE that is used to configure information for the cell group consisting of the one or more candidate cells.

4. The apparatus of claim 1, wherein the configuration information for the LTM procedure comprises a LTM CSI resource configuration information element (IE) to configure a synchronization signal block (SSB) resource set for one or more intra-frequency or inter-frequency candidate cells.

5. The apparatus of claim 4, wherein the LTM CSI resource configuration IE comprises an SSB resource list and a candidate cell Id List.

6. The apparatus of claim 5, wherein a number of entries of the SSB resource list is equal to a number of entries of the candidate cell ID list.

7. The apparatus of claim 5, wherein a first entry of the candidate cell ID list indicates a value of a candidate cell ID for a first entry of the SSB resource list.

8. The apparatus of claim 4, wherein the configuration information for the LTM procedure further comprises an IE to configure resources for channel measurement for each LTM CSI resource configuration IE to associate with a CSI report, the resources for channel measurement IE configured to identify inter-cell channel measurement resources associated with the one or more candidate cells.

9. The apparatus of claim 1, wherein the processing circuitry is further configured to:
configure the transceiver circuitry to transmit, prior to the CSI report for LTM, a layer 3 (L3) measurement report to the base station;
decode, from signaling received from the base station, multiple CSI report type indication for LTM, wherein each type of CSI report type indication corresponds to a different set of synchronization signal blocks (SSBs) and is configured by the network based on the L3 measurement report; and
generate the CSI report for LTM, wherein generating the CSI report for LTM comprises selecting one of multiple CSI report types for LTM based on the CSI report type indications received from the base station.

10. The apparatus of claim 1, wherein the configuration information for the LTM procedure comprises a candidate cell transmission configuration indicator (TCI) state list comprising multiple TCI states.

11. The apparatus of claim 10, wherein the configuration information for the LTM procedure includes a first information element (IE) for each TCI state and a quasi co-location (QCL) source reference signal parameter of the first IE is limited to synchronization signal block (SSB).

12. The apparatus of claim 11, wherein the candidate cell TCI state list is configured on a per candidate cell basis.

13. The apparatus of claim 11, wherein the candidate cell TCI state list is common to multiple candidate cells and includes multiple TCI states.

14. The apparatus of claim 10, wherein the configuration information for the LTM procedure includes a first information element (IE) for each TCI state and a quasi co-location (QCL) source reference signal parameter of the first IE is limited to an index of a synchronization signal block (SSB) and an index of a tracking reference signal (TRS).

15. The apparatus of claim 14, wherein the candidate cell TCI state list is configured on a per candidate cell basis.

16. The apparatus of claim 14, wherein the candidate cell TCI state list is common to multiple candidate cells and includes multiple TCI states.

17. The apparatus of claim 1, further configured to:
Decode, from signaling received from the base station prior to the MAC CE for the cell switch command for the LTM procedure, a second medium access control (MAC) control element (CE) configured to activate one or more TCI states for one or more candidate cells in LTM.

18. The apparatus of claim 17, wherein the one or more TCI states in the second MAC CE are for a single candidate cell.

19. The apparatus of claim 17, the one or more TCI states in the second MAC CE are for multiple candidate cells.

20. The apparatus of claim 19, wherein the second MAC CE comprises multiple candidate cell ID fields configured to indicate whether a TCI state associated with each respective candidate cell ID is activated.
